(19) United States
(12) Patent Application Publication
(10) Pub. No.: US 2009/0141809 A1
(43) Pub. Date: Jun. 4, 2009

(54) Extension to the AVC standard to support the encoding and storage of high resolution digital still pictures in parallel with video

(75) Inventors: Mohammed Zubair Visharam, Santa Clara, CA (US); Ali Tabatabai, Cupertino, CA (US)

Correspondence Address: Jonathan O. Owens;HAVERSTOCK & OWENS LLP, 162 North Wolfe Road, Sunnyvale, CA, 94086, US

(73) Assignee: Sony Corporation and Sony Electronics Inc.

(21) Appl. No.: 11/999,297

(22) Filed: Dec. 4, 2007

(51) Int. Cl. H04B 1/66

(52) U.S. Cl. 375/240.25; 375/E07.19

(57) ABSTRACT

A codec configured to operate in a parallel mode extends the current AVC standard in order to provide support for coding and storage of high resolution still image pictures in parallel with the AVC coding of a lower resolution video. The parallel mode codec is configured according to the modified AVC standard and is capable of capturing an AVC video stream while concurrently capturing high resolution still images at random intervals of the video stream. Residual information stored as an enhancement layer, is used to generate one or more high resolution still images pictures using the up-sampled decoded lower resolution video at the decoder side. A base layer carries lower resolution video. The enhancement layer and the base layer are transmitted in parallel, as a multi-layer stream, from an encoder on the transmission side to a decoder at the receiving side. To carry enhancement information, the AVC standard is extended to include data field(s) for SEI Message Definitions, sequence parameter sets, and a new NAL Unit.

### FIELD OF THE INVENTION

The present invention relates to the field of video encoding. More particularly, the present invention relates to the field of AVC encoding and extending the current AVC standard to support the encoding and storage of high resolution digital still images along with traditionally encoded AVC video streams in an integrated parallel mode.

### BACKGROUND OF THE INVENTION

The term “codec” refers to either “compressor/decompressor”, “coder/decoder”, or “compression/decompression algorithm”, which describes a device or algorithm, or specialized computer program, capable of performing transformations on a data stream or signal. Codecs encode a data stream or signal for transmission, storage or encryption and decode it for viewing or editing. For example, a digital video camera converts analog signals into digital signals, which are then passed through a video compressor for digital transmission or storage. A receiving device then decompresses the received signal via a video decompressor, and the decompressed digital signal is converted to an analog signal for display. A similar process can be performed on audio signals. There are numerous standard codec schemes. Some are used mainly to minimize file transfer time, and are employed on the Internet. Others are intended to minimize the data that can be stored in a given amount of disk space, or on a CD-ROM. Each codec scheme may be handled by different programs, processes, or hardware.

A digital image is a representation of a two-dimensional image as a finite set of digital values, called picture elements or pixels. Typically, pixels are stored in computer memory as a raster image or raster map, which is a two-dimensional array of integers. These values are often transmitted or stored in a compressed form.

Digital images can be created by a variety of input devices and techniques, such as digital cameras and camcorders, scanners, coordinate-measuring machines, seismographic profiling, airborne radar, and more. They can also be synthesized from arbitrary non-image data, such as mathematical functions or three-dimensional geometric models, the latter being a major sub-area of computer graphics. The field of digital image processing is the study or use of algorithms to perform image processing on digital images. Image codecs include such algorithms to perform digital image processing.

Different image codecs are utilized to see the image depending on the image format. The GIF, JPEG and PNG images can be seen simply using a web browser because they are the standard internet image formats. The SVG format is now widely used in the web and is a standard W3C format. Other programs offer a slideshow utility, to see the images in a certain order one after the other automatically.

Still images have different characteristics than video. For example, the aspect ratios and the colors are different. As such, still images are processed differently than video, thereby requiring a still image codec for still images and a video codec, different from the still image codec, for video.

A video codec is a device or software module that enables the use of data compression techniques for digital video data. A video sequence consists of a number of pictures (digital images), usually called frames. Subsequent frames are very similar, thus containing a lot of redundancy from one frame to the next. Before being efficiently transmitted over a channel or stored in memory, video data is compressed to conserve both bandwidth and memory. The goal of video compression is to remove the redundancy, both within frames (spatial redundancy) and between frames (temporal redundancy) to gain better compression ratios. There is a complex balance between the video quality, the quantity of the data needed to represent it (also known as the bit rate), the complexity of the encoding and decoding algorithms, their robustness to data losses and errors, ease of editing, random access, end-to-end delay, and a number of other factors.

A typical digital video codec design starts with the conversion of input video from a RGB color format to a YCbCr color format, and often followed by chroma sub-sampling to produce a sampling grid pattern. Conversion to the YCbCr color format improves compressibility by de-correlating the color signals, and separating the perceptually more important luma signal from the perceptually less important chroma signal, and which can be represented at lower resolution.

Some amount of spatial and temporal down-sampling may also be used to reduce the raw data rate before the basic encoding process. Down-sampling is the process of reducing the sampling rate of a signal. This is usually done to reduce the data rate or the size of the data. The down-sampling factor is typically an integer or a rational fraction greater than unity. This data is then transformed using a frequency transform to further de-correlate the spatial data. One such transform is a discrete cosine transform (DCT). The output of the transform is then quantized and entropy encoding is applied to the quantized values. Some encoders can compress the video in a multiple step process called n-pass encoding, for example 2-pass, which is generally a slower process, but potentially provides better quality compression.

The decoding process consists of essentially performing an inversion of each stage of the encoding process. The one stage that cannot be exactly inverted is the quantization stage. There, a best-effort approximation of inversion is performed. This part of the process is often called “inverse quantization” or “dequantization”, although quantization is an inherently non-invertible process.

A variety of codecs can be easily implemented on PCs and in consumer electronics equipment. Multiple codecs are often available in the same product, avoiding the need to choose a single dominant codec for compatibility reasons.

Some widely-used video codecs include, but are not limited to, H.261, MPEG-1 Part 2, MPEG-2 Part 2, H.263, MPEG-4 Part 2, MPEG-4 Part 10/AVC, DivX, XviD, 3ivx, Sorenson 3, and Windows Media Video (MWV).

H.261 is used primarily in older videoconferencing and videotelephony products. H.261 was the first practical digital video compression standard. Essentially all subsequent standard video codec designs are based on it. It included such well-established concepts as YCbCr color representation, the 4:2:0 sampling format, 8-bit sample precision, 16×16 macroblocks, block-wise motion compensation, 8×8 block-wise discrete cosine transformation, zig-zag coefficient scanning, scalar quantization, run+value symbol mapping, and variable-length coding. H.261 supported only progressive scan video.

MPEG-1 Part 2 is used for Video CDs (VCD), and occasionally for online video. The quality is roughly comparable to that of VHS. If the source video quality is good and the bitrate is high enough, VCD can look better than VHS, however, VCD requires high bitrates for this. VCD has the highest compatibility of any digital video/audio system, as almost every computer in the world can play this codec. In terms of technical design, the most significant enhancements in MPEG-1 relative to H.261 were half-pel and bi-predictive motion compensation support. MPEG-1 supported only progressive scan video.

MPEG-2 Part 2 is a common-text standard with H.262 and is used on DVD and in most digital video broadcasting and cable distribution systems. When used on a standard DVD, MPEG-2 Part 2 offers good picture quality and supports widescreen. In terms of technical design, the most significant enhancement in MPEG-2 relative to MPEG-1 was the addition of support for interlaced video. MPEG-2 is considered an aging codec, but has significant market acceptance and a very large installed base.

H.263 is used primarily for videoconferencing, videotelephony, and internet video. H.263 represented a significant step forward in standardized compression capability for progressive scan video. Especially at low bit rates, H.263 could provide a substantial improvement in the bit rate needed to reach a given level of fidelity.

MPEG-4 Part 2 is an MPEG standard that can be used for internet, broadcast, and on storage media. MPEG-4 Part 2 offers improved quality relative to MPEG-2 and the first version of H.263. Its major technical features beyond prior codec standards consisted of object-oriented coding features. MPEG-4 Part 2 also included some enhancements of compression capability, both by embracing capabilities developed in H.263 and by adding new ones such as quarter-pel motion compensation. Like MPEG-2, it supports both progressive scan and interlaced video.

MPEG-4 Part 10 is a technically aligned standard with the ITU-T's H.264 and is often also referred to as AVC. MPEG-4 Part 10 contains a number of significant advances in compression capability, and it has recently been adopted into a number of company products.

DivX, XviD and 3 ivx are video codec packages basically using MPEG-4 Part 2 video codec, with the *.avi, *.mp4, *.ogm or *.mkv file container formats. Sorenson 3 is a codec that is popularly used by Apple's QuickTime, basically the ancestor of H.264. Many of the Quicktime Movie trailers found on the web use this codec. WMV (Windows Media Video) is Microsoft's family of video codec designs including WMV 7, WMV 8, and WMV 9. WMV can be viewed as a version of the MPEG-4 codec design.

MPEG codecs are used for the generic coding of moving pictures and associated audio. MPEG video codecs create a compressed video bit-stream traditionally made up of a series of three types of encoded data frames. The three types of data frames are referred to as an intra frame (called an I-frame or I-picture), a bi-directional predicated frame (called a B-frame or B-picture), and a forward predicted frame (called a P-frame or P-picture). These three types of frames can be arranged in a specified order called the GOP (Group Of Pictures) structure. I-frames contain all the information needed to reconstruct a picture. The I-frame is encoded as a normal image without motion compensation. On the other hand, P-frames use information from previous frames and B-frames use information from previous frames, a subsequent frame, or both to reconstruct a picture. Specifically, P-frames are predicted from a preceding I-frame or the immediately preceding P-frame.

Frames can also be predicted from the immediate subsequent frame. In order for the subsequent frame to be utilized in this way, the subsequent frame must be encoded before the predicted frame. Thus, the encoding order does not necessarily match the real frame display order. Such frames are usually predicted from two directions, for example from the I- or P-frames that immediately precede or the P-frame that immediately follows the predicted frame. These bidirectionally predicted frames are called B-frames.

There are many possible GOP structures. A common GOP structure is 15 frames long, and has the sequence I_BB_P_BB_P_BB_P_BB_P_BB_. A similar 12-frame sequence is also common. I-frames encode for spatial redundancy, P and B-frames for temporal redundancy. Because adjacent frames in a video stream are often well-correlated, P-frames may be 10% of the size of I-frames, and B-frames 2% of their size. However, there is a trade-off between the size to which a frame can be compressed versus the processing time and resources required to encode such a compressed frame. The ratio of I, P and B-frames in the GOP structure is determined by the nature of the video stream and the bandwidth constraints on the output stream, although encoding time may also be an issue. This is particularly true in live transmission and in real-time environments with limited computing resources, as a stream containing many B-frames can take much longer to encode than an I-frame-only file.

B-frames and P-frames require fewer bits to store picture data, as they generally contain difference bits for the difference between the current frame and a previous frame, subsequent frame, or both. B-frames and P-frames are thus used to reduce the redundant information contained across frames. A decoder in operation receives an encoded B-frame or encoded P-frame and uses a previous or subsequent frame to reconstruct the original frame. This process is much easier than reconstructing each original frame independently and produces smoother scene transitions when sequential frames are substantially similar, since the difference in the frames is small.

Each video image is separated into one luminance (Y) and two chrominance channels (also called color difference signals Cb and Cr). Blocks of the luminance and chrominance arrays are organized into “macroblocks,” which are the basic unit of coding within a frame.

In the case of I-frames, the actual image data is passed through an encoding process. However, P-frames and B-frames are first subjected to a process of “motion compensation.” Motion compensation is a way of describing the difference between consecutive frames in terms of where each macroblock of the former frame has moved. Such a technique is often employed to reduce temporal redundancy of a video sequence for video compression. Each macroblock in the P-frame or B-frame is associated with an area in the previous or next image that it is well-correlated with, as selected by the encoder using a “motion vector” that is obtained by a process termed “Motion Estimation.” The motion vector that maps the current macroblock to its correlated area in the reference frame is encoded, and then the difference between the two areas is passed through the encoding process.

Conventional video codecs use motion compensated prediction to efficiently encode a raw input video stream. The macroblock in the current frame is predicted from a displaced macroblock in the previous frame. The difference between the original macroblock and its prediction is compressed and transmitted along with the displacement (motion) vectors. This technique is referred to as inter-coding, which is the approach used in the MPEG standards.

The output bit-rate of an MPEG encoder can be constant or variable, with the maximum bit-rate determined by the playback media. To achieve a constant bit-rate, the degree of quantization is iteratively altered to achieve the output bit-rate requirement. Increasing quantization leads to visible artifacts when the stream is decoded. The discontinuities at the edges of macroblocks become more visible as the bit-rate is reduced.

The AVC (H.264) standard supports quality video at bit-rates that are substantially lower than what the previous standards would need. This functionality allows the standard to be applied to a very wide variety of video applications and to work well on a wide variety of networks and systems. Although the MPEG video coding standards specify general coding methodology and syntax for the creation of a legitimate MPEG video bit-stream, the current standards do not provide support for encoding and storing randomly captured high resolution still images along with the encoded video data.

### SUMMARY OF THE INVENTION

A codec configured to operate in a parallel mode extends the current AVC standard in order to provide support for coding and storage of high resolution still image pictures in parallel with the AVC coding of a lower resolution video. The parallel mode codec is configured according to the modified AVC standard. The codec is capable of capturing an AVC video stream while concurrently capturing high resolution still images at random intervals relative to the video stream. Residual information stored as an enhancement layer, is used to generate one or more high resolution still images pictures using the up-sampled decoded lower resolution video at the decoder side. A base layer carries lower resolution video. The enhancement layer and the base layer are transmitted in parallel, as a multi-layer stream, from an encoder on the transmission side to a decoder on the receiving side.

To carry enhancement information, the AVC standard is extended to include data field(s) for SEI Message Definitions, sequence parameter sets, and a new NAL Unit. In one embodiment, a modified sequence parameter set defines a new profile that signals the presence of high resolution still images in parallel with AVC video. The new NAL Unit defines a new digital still image mode NAL by using a reserved NAL unit type to store the residual information.

In one aspect, a method of encoding data is described. The method includes capturing a video stream of data, wherein the video stream includes a plurality of successive video frames of data, encoding the video stream of data to form an encoded video stream, capturing one or more still images, wherein each still image is captured at a random interval of time relative to the video stream, determining a residual information packet associated with each captured still image, wherein a first residual information packet is the difference between a first captured original still image and a first decoded up-sampled video frame of the video stream corresponding to the first captured still image, encoding the residual information packet associated with each captured still image to form an encoded residual stream, and transmitting the encoded video stream and the encoded residual stream in parallel as a multi-layer transmission. Determining the first residual information packet can comprise up-sampling the first decoded video frame and determining the difference between the first captured original still image and the decoded up-sampled first video frame. The method can also include defining a modified sequence parameter set including a new profile indicator, wherein the new profile indicator includes a still image flag which when true, signals one or more still image parameters, and further wherein each still image parameter defines a characteristic of the still image, such as one or more of image height and image width. The method can also include defining a new NAL unit type to store the residual information packet associated with each captured still image. The method can also include receiving the multi-layer transmission, decoding the encoded video stream to form the plurality of successive video frames, decoding the encoded residual stream to form the residual information packet associated with each captured still image, up-sampling each decoded video frame that corresponds to each residual information packet, and adding the appropriate residual information packet to each corresponding up-sampled decoded video frame to form the one or more of the high resolution still images. Each still image can comprise a high resolution still image. Each video frame can comprise a low resolution video frame. A frame rate of the video stream can be independent of a frame rate of the residual information packets. The residual information packets can be encoded according to a modified AVC standard that employs intra coding tools of the AVC standard.

In another aspect, a system to encode data is described. The system includes a video capturing module to capture a video stream of data, wherein the video stream includes a plurality of successive video frames of data, a still image capturing module to capture one or more still images, wherein each still image is captured at a random interval of time relative to the video stream, a processing module to determine a difference between a first captured still image and a first decoded up-sampled video frame of the video stream corresponding to the first captured still image, thereby generating a residual information packet associated with each captured still image, an encoder to encode the video stream of data to form an encoded video stream and to encode the residual information packet associated with each captured still image to form an encoded residual stream, and an output module to transmit the encoded video stream and the encoded residual stream in parallel as a multi-layer transmission. The encoder can include an up-sampling module to up-sample the first decoded video frame, such that the residual information packet comprises the difference between the first captured still image and the up-sampled decoded first video frame. The processing module can also be configured to define a modified sequence parameter set including a new profile indicator, wherein the new profile indicator includes a still image flag which when true, signals one or more still image parameters, and further wherein each still image parameter defines a characteristic of the still image, such as one or more of image height and image width. The processing module can also be configured to define a NAL unit type to store the residual information packet associated each captured still image. Each still image can comprise a high resolution still image. Each video frame can comprise a low resolution video frame. A frame rate of the video stream can be independent of a frame rate of the residual information packets. The residual information packets can be encoded according to a modified AVC standard that employs intra coding tools of the AVC standard.

In yet another aspect, a system to decode data is described. The system includes a receiver to receive an encoded video stream and an encoded residual stream in parallel as a multi-layer transmission, a decoder to decode the encoded video stream, thereby forming a video stream of data including a plurality of successive video frames, and to decode the encoded residual stream, thereby forming one or more residual information packets, wherein a first residual information packet is associated with a first decoded up-sampled video frame of the video stream, and a processing module to add the first residual information packet to the first decoded up-sampled video frame to generate a first still image, wherein each still image is generated at a random interval of time relative to the video stream. The decoder can include an up-sampling module to up-sample the first video frame, such that the first still image is generated by adding the first residual information packet to the decoded up-sampled first video frame. The decoder reads from a modified sequence parameter set, a presence of a new profile and a still image flag, that signals one or more still image parameters and the processing module is further configured to read the one or more still image parameters, wherein each still image parameter defines a characteristic of the still image, such as one or more of image height and image width. Each still image can comprise a high resolution still image. Each video frame can comprise a low resolution video frame. A frame rate of the video stream can be independent of a frame rate of the residual information packets. The residual information packets can be encoded according to a modified AVC standard that employs intra coding tools of the AVC standard.

In still yet another aspect, a system to encode and decode data is described. The system includes a video capturing module to capture a first video stream of data, wherein the first video stream includes a plurality of successive video frames of data, a still image capturing module to capture one or more still images, wherein each still image is captured at a random interval of time relative to the first video stream, a processing module to determine a difference between a first captured still image and a first decoded up-sampled video frame of the first video stream corresponding to the first captured still image, thereby generating a residual information packet associated with each captured still image, an encoder to encode the first video stream of data to form a first encoded video stream and to encode the residual information packet associated with each captured still image to form a first encoded residual stream, a transceiver to transmit the first encoded video stream and the first encoded residual stream in parallel as a first multi-layer transmission, and to receive a second encoded video stream and a second encoded residual stream in parallel as a second multi-layer transmission, and a decoder to decode the second encoded video stream, thereby forming a second video stream of data including a plurality of successive video frames, and to decode the second encoded residual stream, thereby forming one or more residual information packets, wherein a second residual information packet is associated with a second decoded up-sampled video frame of the second video stream, wherein the processing module is further configured to add the second residual information packet to the second decoded up-sampled video frame to generate a high resolution still image.

### BRIEF DESCRIPTION OF THE DRAWINGS

FIG. 1 illustrates a parallel mode using a modified AVC standard to store high resolution still images.

FIG. 2 illustrates a block diagram of an exemplary imaging system configured to operate in the sequential mode.

FIG. 3 illustrates an exemplary process flow of the encoder from FIG. 2.

FIG. 4 illustrates an exemplary process flow of the decoder from FIG. 2.

Embodiments of the parallel mode codec are described relative to the several views of the drawings. Where appropriate and only where identical elements are disclosed and shown in more than one drawing, the same reference numeral will be used to represent such identical elements.

### DETAILED DESCRIPTION OF THE EMBODIMENTS

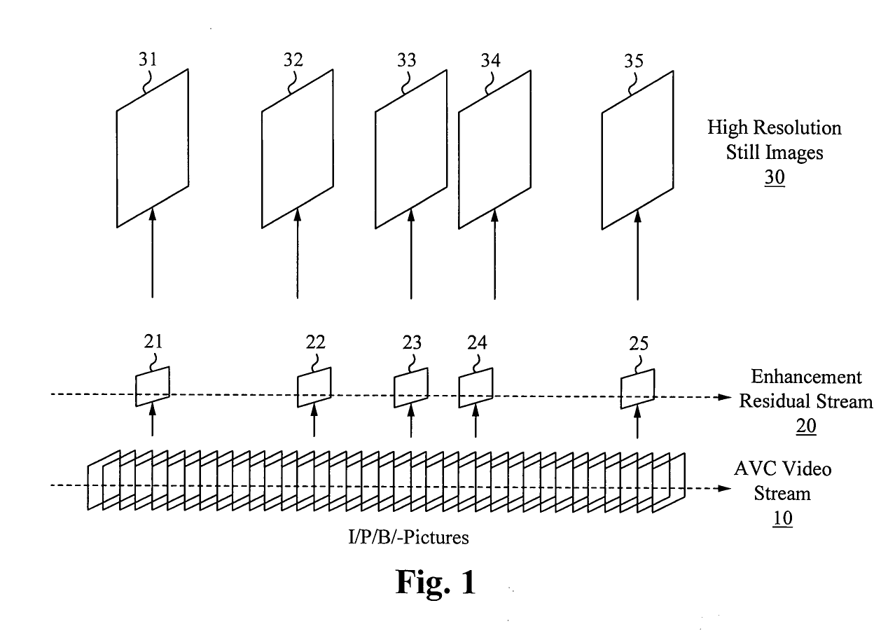

FIG. 1 illustrates a parallel mode using a modified AVC standard to store high resolution still images in parallel with traditionally encoded AVC video. An AVC formatted video stream 10 includes a succession of video frames. An enhancement residual stream 20 includes residual information corresponding to one or more high resolution still images 30 captured at random intervals. For each high resolution still image 31, 32, 33, 34, and 35, there is corresponding residual information 21, 22, 23, 24, and 25 in the enhancement residual stream 20. Although five high resolution still images are shown in FIG. 1, it is understood that more or less than five high resolution still images can be captured. The residual information is the difference between the original high resolution still image and the corresponding decoded up-sampled low resolution video frame.

The modified AVC standard enables each high resolution still image to be captured at any random interval. In other words, the frame rate of the residual information (the residual information 21-25) does not need to match the frame rate of the AVC video stream 10, although in some circumstances the frame rates are equal. As opposed to conventional codecs that require residual information to be generated at a fixed rate relative to the video stream, the parallel mode codec configured according to the modified AVC standard is not encumbered by such a requirement. The residual information transmitted using the parallel mode codec is at a frame rate independent of the frame rate for the video stream.

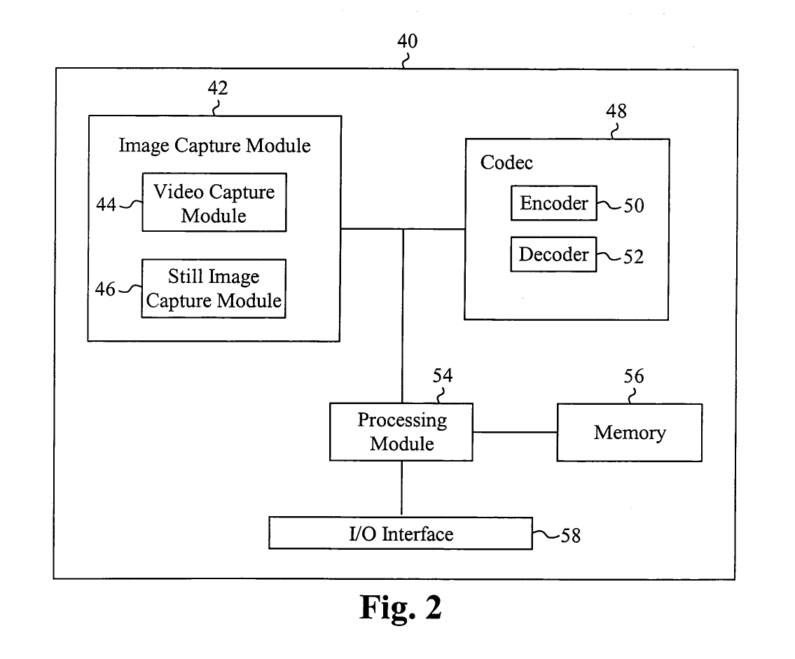

FIG. 2 illustrates a block diagram of an exemplary imaging system 40 configured to operate in the parallel mode. The imaging system 40 includes an image capture module 42, a codec 48, a processing module 54, a memory 56, and an input/output (I/O) interface 58. The I/O interface 58 includes a user interface and a network interface for transmitting and receiving data. The memory 56 is any conventional type of data storage medium, either integrated or removable. The codec 48 includes an encoder 50 and a decoder 52. The image capture module 42 includes a video capture module 44 for capturing low resolution video and a still image capture module 46 for capturing high resolution still images.

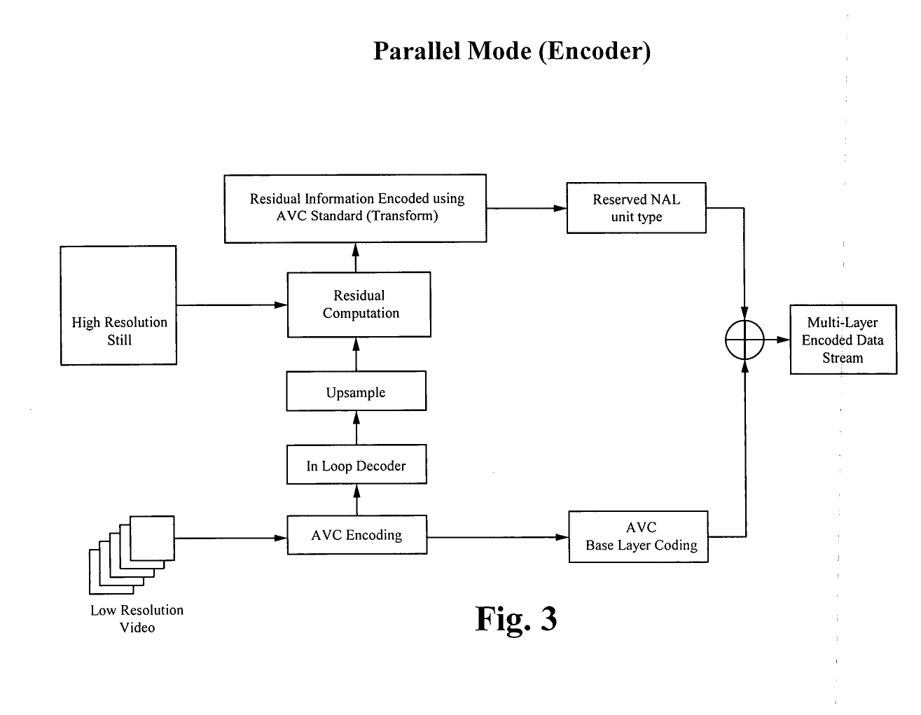

FIG. 3 illustrates an exemplary process flow of the encoder from FIG. 2. The encoder encodes high resolution still images in parallel with the AVC coding of a lower resolution video stream. A low resolution input video stream comprised of successive frames, such as the video stream 10 (FIG. 1), is captured. The low resolution video stream is encoded according to the AVC standard. At any random instant of time, a high resolution still image is captured, such as one or more of the high resolution still images 31-35 (FIG. 1). Other still images can be captured at other instances of time. Once the high resolution still image is captured, the corresponding residual information is determined based on the difference between the original high resolution still image and an up-sampled decoded version of the particular video frame in the low resolution AVC video stream that corresponds in time to the instant that the high resolution still image was captured. The residual information corresponding to each high resolution still image is encoded using a modified version of the AVC standard that employs intra coding tools of AVC. The residual information associated with the captured high resolution still image is contained in a new NAL Unit. The encoded residual information for each high resolution still image forms an enhanced residual stream, such as the enhancement residual stream 20 (FIG. 1). The encoded low resolution video frames are transmitted form an AVC video stream, such as the AVC video stream 10 (FIG. 1). The frame rate of the enhancement residual stream is independent of the frame rate of the AVC video stream. The enhancement residual stream and the AVC video stream are added to form a multi-layer encoded data stream, which is transmitted from the encoder to the decoder as a multi-layer transmission.

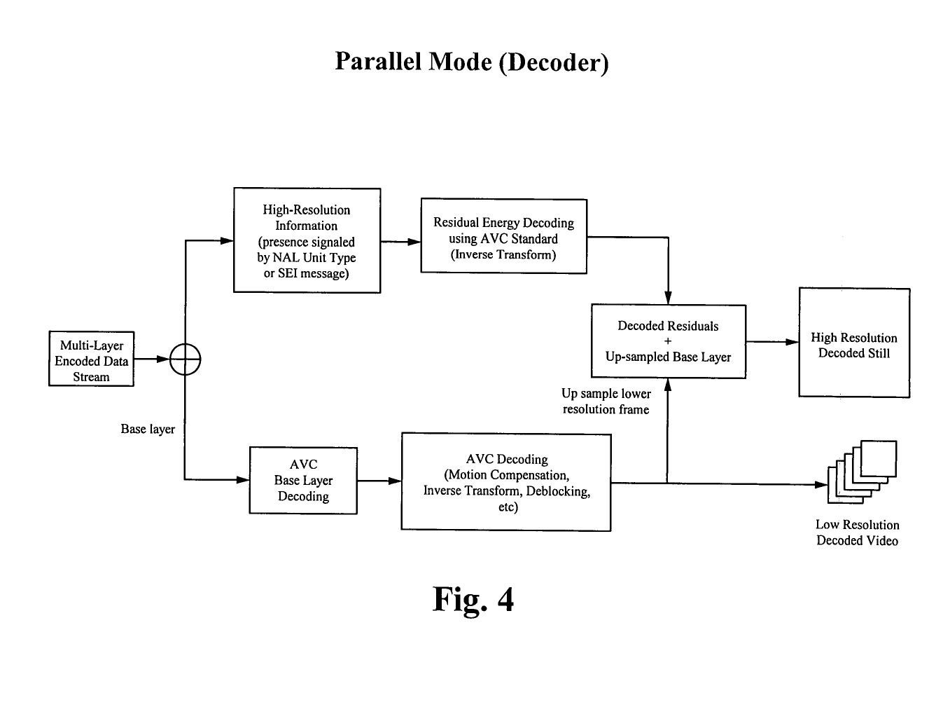

On a decoder side, a substantially reverse operation is performed where the residual information is added to the corresponding up-sampled decoded video frame. FIG. 4 illustrates an exemplary process flow of the decoder from FIG. 2. The decoder receives the multi-layer encoded data stream transmitted from the encoder (FIG. 4). The enhancement residual stream is separated from the AVC video stream. The base layer AVC video stream is decoded according to AVC decoding thereby forming the low resolution video stream.

The residual information for each high resolution still image is distinguished within the enhancement residual stream, the presence of each high resolution still image is signaled by the NAL unit type. The encoded residual information for each high resolution still image is decoded according to the modified AVC standard employing the intra coding tools. For each high resolution still image represented by the decoded enhancement residual stream, a corresponding video frame in the decoded video stream is up-sampled. The up-sampled base layer is added to the corresponding decoded residual information to form the high resolution still image.

The up-sampling operations at both the encoder and the decoder are substantially similar. As an example, for horizontal and vertical resolutions with an up-sampling factor of two (2), the up-sampling filters for half-pel motion estimation, as specified in AVC, are a candidate solution. Also, the up-sampling factors are not restricted to a power of two (2) and are able to be fractional as well.

To modify the existing AVC standard to support such random capture of high resolution still images, the existing AVC standard is extended to enable enhancement information at random intervals of time and to signal this enhancement information to the decoder. A sequence parameter set defines the characteristics of the video stream at a particular instant in time.

The modified AVC standard includes a modified sequence parameter set (SPS) RBSP syntax. In one embodiment, the modified sequence parameter set signals the presence of a high resolution still images in the stream by defining a new profile indicator. The presence of the new profile signals a corresponding flag, which when true signals the width and height of the high resolution still image are defined. The following is an exemplary modified SPS RBSP syntax:

```
seq_parameter_set_rbsp( ) {
  profile_idc
  constraint_set0_flag
  constraint_set1_flag
  constraint_set2_flag
  constraint_set3_flag
  reserved_zero_4bits /* equal to 0 */
  level_idc
  seq_parameter_set_id
  if (profile_idc = = ‘NNN’) {//new un-used 8-bit integer for profile
    indicator for parallel mode
    still_picture_parallel_present _flag
  }
  if (profile_idc = = 100 || profile_idc = = 110 ||
    profile_idc = = 122 || profile_idc = = 144 ||
    profile_idc = = 83)) {
    chroma_format_idc
    if( chroma_format_idc = = 3)
      residual_colour_transform_flag
    bit_depth_luma_minus8
    bit_depth_chroma_minus8
    qpprime_y_zero_transform_bypass_flag
    seq_scaling_matrix_present flag
    if( seq_scaling_matrix_present_flag)
      for( i = 0; i < 8; i++) {
        seq_scaling_list_present_flag[i]
        if( seq_scaling_list_present_flag[i])
          if( i < 6)
            scaling_list( ScalingList4×4[i], 16,
              UseDefaultScalingMatrix4×4Flag[i])
          else
            scaling list( ScalingList8×8[i−6], 64,
              UseDefaultScalingMatrix8×8Flag[i−6])
      }
  }
  log2_max_frame_num_minus4
  pic_order_cnt_type
  if( pic_order_cnt_type = = 0)
    log2_max_pic_order_cnt_lsb_minus4
  else if( pic_order_cnt_type = = 1) {
    delta_pic_order_always_zero_flag
    offset_for_non_ref_pic
    offset_for_top_to_bottom_field
    num_ref_frames_in_pic_order_cnt_cycle
    for( 1 = 0; i < num_ref_frames_in_pic_order_cnt_cycle; i++)
      offset_for_ref_frame[i]
  }
  num_ref_frames
  gaps_in_frame_num_value_allowed_flag
  pic_width_in_mbs_minusl
  pic_height_in_map_units_minusl
  if( still_picture_parallel_present _flag) {
    still_pic_width_in_mbs_minusl
    still_pic_height_in_map_units_minusl
  }
  frame_mbs_only_flag
  if( !frame_mbs_only_flag)
    mb_adaptive_frame_field_flag
  direct_8×8_inference_flag
  frame_cropping_flag
  if( frame_cropping_flag) {
    frame_crop_left_offset
    frame_crop_right_offset
    frame_crop_top_offset
    frame_crop_bottom_offset
  }
  vui_parameters_present_flag
  if( vui_parameters_present_flag)
    vui_pammeters( )
  rbsp_trailing_bits( )
}
```

The parameter “still_pic_width_in_mbs_minus1” plus 1 specifies the width of each decoded high resolution still picture in units of macroblocks. The parameter “still_pic_height_in_map_units_minus1” plus 1 specifies the height in slice group map units of a decoded frame of the high resolution still picture.

The modified AVC standard also includes modified NAL Unit syntax for enhancement layer information. To support such a modified NAL Unit syntax, one of the reserved NAL Unit types is used to store the enhancement layer information for the high resolution still image pictures.

The modified AVC standard also includes a SEI Message Definition to signal the presence of the high resolution still image picture “residual information” in an access unit. The residual information for the high-resolution still image pictures is stored as “enhancement layer information” in a new NAL unit type as described above.

In the case where a decoder is instructed to parse/display only the high resolution still image pictures from the coded video stream, the decoder parses through all the NAL units headers in all access units to determine if an Access Unit contains an enhancement NAL unit type. To overcome this, an SEI message type is defined, which if present in an Access Unit, signals the presence of enhancement layer information for that particular still image picture. Since SEI messages occur before the primary coded picture in an Access Unit, the decoder is signaled beforehand about the presence of a high resolution still image picture in an access unit.

The modified AVC standard includes a high resolution still image picture SEI message syntax. The following is an exemplary high resolution still image picture SEI message syntax:

hiresolution_picture_presence(payloadSize) {
hiresolution_picture_present_flag
}

When the parameter “hiresolution_picture_present_flag” is equal to 1, this signals the presence of a high resolution still image picture in an access unit.

It is understood that the syntax used above to define the modified sequence parameter set and the SEI message definition is for exemplary proposes and that alternative syntax can be used to define the modified sequence parameter set and the SEI message definition.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1. A method of encoding data, the method comprising:
a. capturing a video stream of data, wherein the video stream includes a plurality of successive video frames of data;
b. encoding the video stream of data to form an encoded video stream;
c. capturing one or more still images, wherein each still image is captured at a random interval of time relative to the video stream;
d. determining a residual information packet associated with each captured still image, wherein a first residual information packet is the difference between a first captured original still image and a first decoded up-sampled video frame of the video stream corresponding to the first captured still image;
e. encoding the residual information packet associated with each captured still image to form an encoded residual stream; and
f. transmitting the encoded video stream and the encoded residual stream in parallel as a multi-layer transmission.

2. The method of claim 1 wherein determining the first residual information packet comprises up-sampling the first decoded video frame and determining the difference between the first captured original still image and the decoded up-sampled first video frame.

3. The method of claim 1 further comprising defining a modified sequence parameter set including a new profile indicator, wherein the new profile indicator includes a still image flag which when true, signals one or more still image parameters, and further wherein each still image parameter defines a characteristic of the still image, such as one or more of image height and image width.

4. The method of claim 1 further comprising defining a new NAL unit type to store the residual information packet associated with each captured still image.

5. The method of claim 1 further comprising:
a. receiving the multi-layer transmission;
b. decoding the encoded video stream to form the plurality of successive video frames;
c. decoding the encoded residual stream to form the residual information packet associated with each captured still image;
d. up-sampling each decoded video frame that corresponds to each residual information packet; and
d. adding the appropriate residual information packet to each corresponding up-sampled decoded video frame to form the one or more of the high resolution still images.

6. The method of claim 1 wherein each still image comprises a high resolution still image.

7. The method of claim 1 wherein each video frame comprises a low resolution video frame.

8. The method of claim 1 wherein a frame rate of the video stream is independent of a frame rate of the residual information packets.

9. The method of claim 1 wherein the residual information packets are encoded according to a modified AVC standard that employs intra coding tools of the AVC standard.

10. A system to encode data comprising:
a. a video capturing module to capture a video stream of data, wherein the video stream includes a plurality of successive video frames of data;
b. a still image capturing module to capture one or more still images, wherein each still image is captured at a random interval of time relative to the video stream;
c. a processing module to determine a difference between a first captured still image and a first decoded up-sampled video frame of the video stream corresponding to the first captured still image, thereby generating a residual information packet associated with each captured still image;
d. an encoder to encode the video stream of data to form an encoded video stream and to encode the residual information packet associated with each captured still image to form an encoded residual stream; and
e. an output module to transmit the encoded video stream and the encoded residual stream in parallel as a multi-layer transmission.

11. The system of claim 10 wherein the encoder includes an up-sampling module to up-sample the first decoded video frame, such that the residual information packet comprises the difference between the first captured still image and the up-sampled decoded first video frame.

12. The system of claim 10 wherein the processing module is further configured to define a modified sequence parameter set including a new profile indicator, wherein the new profile indicator includes a still image flag which when true, signals one or more still image parameters, and further wherein each still image parameter defines a characteristic of the still image, such as one or more of image height and image width.

13. The system of claim 10 wherein the processing module is further configured to define a NAL unit type to store the residual information packet associated each captured still image.

14. The system of claim 10 wherein each still image comprises a high resolution still image.

15. The system of claim 10 wherein each video frame comprises a low resolution video frame.

16. The system of claim 10 wherein a frame rate of the video stream is independent of a frame rate of the residual information packets.

17. The system of claim 10 wherein the residual information packets are encoded according to a modified AVC standard that employs intra coding tools of the AVC standard.

18. A system to decode data comprising:
a. a receiver to receive an encoded video stream and an encoded residual stream in parallel as a multi-layer transmission;
b. a decoder to decode the encoded video stream, thereby forming a video stream of data including a plurality of successive video frames, and to decode the encoded residual stream, thereby forming one or more residual information packets, wherein a first residual information packet is associated with a first decoded up-sampled video frame of the video stream; and
c. a processing module to add the first residual information packet to the first decoded up-sampled video frame to generate a first still image, wherein each still image is generated at a random interval of time relative to the video stream.

19. The system of claim 18 wherein the decoder includes an up-sampling module to up-sample the first video frame, such that the first still image is generated by adding the first residual information packet to the decoded up-sampled first video frame.

20. The system of claim 18 wherein the decoder reads from a modified sequence parameter set, a presence of a new profile and a still image flag, that signals one or more still image parameters and the processing module is further configured to read the one or more still image parameters, wherein each still image parameter defines a characteristic of the still image, such as one or more of image height and image width.

21. The system of claim 18 wherein each still image comprises a high resolution still image.

22. The system of claim 18 wherein each video frame comprises a low resolution video frame.

23. The system of claim 18 wherein a frame rate of the video stream is independent of a frame rate of the residual information packets.

24. The system of claim 18 wherein the residual information packets are encoded according to a modified AVC standard that employs intra coding tools of the AVC standard.

25. A system to encode and decode data, the system comprising:
a. a video capturing module to capture a first video stream of data, wherein the first video stream includes a plurality of successive video frames of data;
b. a still image capturing module to capture one or more still images, wherein each still image is captured at a random interval of time relative to the first video stream;
c. a processing module to determine a difference between a first captured still image and a first decoded up-sampled video frame of the first video stream corresponding to the first captured still image, thereby generating a residual information packet associated with each captured still image;
d. an encoder to encode the first video stream of data to form a first encoded video stream and to encode the residual information packet associated with each captured still image to form a first encoded residual stream;
e. a transceiver to transmit the first encoded video stream and the first encoded residual stream in parallel as a first multi-layer transmission, and to receive a second encoded video stream and a second encoded residual stream in parallel as a second multi-layer transmission; and
f. a decoder to decode the second encoded video stream, thereby forming a second video stream of data including a plurality of successive video frames, and to decode the second encoded residual stream, thereby forming one or more residual information packets, wherein a second residual information packet is associated with a second decoded up-sampled video frame of the second video stream;
wherein the processing module is further configured to add the second residual information packet to the second decoded up-sampled video frame to generate a high resolution still image.
